(19) United States
(12) Patent Application Publication
(10) Pub. No.: US 2003/0104857 A1
(43) Pub. Date: Jun. 5, 2003

(54) Dual lottery, gaming and annuity system with guaranteed payoff

(76) Inventor: Marcus Jenkins, Stockridge, GA (US)

Correspondence Address: William L. Muckelroy, Esq., P.C., Ewing Professional Building, Suite 3A, 1901 N. Olden Avenue, Trenton, NJ, 08618, US

(21) Appl. No.: 10/012,095

(22) Filed: Dec. 5, 2001

(51) Int. Cl. G06F 17/00

(52) U.S. Cl. 463/17

(57) ABSTRACT

An annuity and lottery game is designed to combine each in a system which guarantees a payoff to each player by requiring two currency denominated units for each chance with one of the units being allocated in a permanent player or bettor account to encompass lottery and annuity benefits. It grants the wishes of those with the hope of immediate gratification through a jackpot and at the same time provides for long term warranted return on each one-half of the price for a lottery chance or ticket. The system is designed so that to play the lottery game, a player is assigned an account number or identification number when a lottery ticket is purchased. Each account number also serves as a login name and password to access an internet display of the account's status. Thus, via the internet, after the account number is in the system, the player can access the system at will to obtain the present and project future value of the account using standard algorithms. The lottery game played is any of the standard common varieties, for example, a 6-7 number Selection from 45 to 50 possible numbers. As in other jackpot systems, winners are awarded money by matching 4,5,6, or 7 numbers. The amount of the winnings is determined by a standard percentage formula and by the amount of numbers matched. A predetermined jackpot would start at a specified dollar amount and increase indefinitely over specified time units such a weekly, for example, until a jackpot winner is selected. To play the game, a player purchases tickets in double currency units, for example $2 each and initially the vendor's terminal assigns an account number which is bar coded for subsequent reading. Any subsequent purchase by a player is made by presenting the prior ticket for scanning the account number previously assigned. Each ticket is a bearer instrument with a guaranteed value at a future date certain, for example 20 years of one currency unit or one dollar. A plurality of account numbers and their underlying values can be combined by presenting to a vendor and scanning at any terminal. At the option of the vendor a transaction fee not to exceed 25 cents, for example, is charged to encourage players to retain and use a single account number. A portion of the transaction fee is shared with the State lottery sponsor to cover administrative costs. For every $2 spent, one dollar will go into the jackpot system while the other dollar goes into the investment portion of the gaming system. This invested dollar is placed in investment grade securities and bonds as with pension funds under the guidance of a State sponsored investment corporation. As the player continues to play the game over time, investment dollars continue to grow along with the interest and dividends as a percentage of the underlying investment unit. The investment under each account may be withdrawn by the ticket bearer and matures as vested to the bearer after a fixed number of years. Accounts not claimed within a fixed time after maturity flow into remaining active accounts in the manner of a tontine.

### BACKGROUND OF THE INVENTION

1. Field of the Invention

The present invention relates to lottery systems in general and, in particular, to a lottery system capable of providing a guaranteed win contingent only on life expectancy and based merely on participation by purchasing one or more chances, each for a price x over a time period y wherein the guaranteed win is x plus a factor not less than one times x and wherein the guaranteed win increases as y increases.

2. Description of Prior Art

Ordinary lottery systems operate in such a manner as to sell lottery tickets for a certain total amount of money, and then to distribute a relatively small part of the total as winnings to a relatively few winning tickets. On average, the return per unit invested, which unit in the U.S. is invariably a dollar is typically well below 50% or fifty cents to the dollar. Most participants in lotteries are aware of this but view the dollar unit of investment as trivial and tend to view the unit purchased as no significant value unless the participant actually wins with 3, 4, or 5 numbers or in the case of super lotteries 6 numbers or 5 numbers plus a special designated and specially selected number usually referred to as a power ball number.

From a psychological standpoint people apparently tend to buy state sponsored lottery units or chances due to the psychological satisfaction associated with the possibility of winning a single large sum of money and accept the fact that the actual return of capital per unit is exceedingly poor. State sponsored lotteries have engaged in advertising to counteract the public cognizance of the poor chance of actually winning and have prominently promoted that a portion of the funds are used for state sponsored charitable purposes such as programs for the poor, children, and senior citizens to encourage the public to continue to periodically participate on a weekly basis.

Accordingly, there is need for a lottery system for use by the state where a participate can actually participate on a weekly basis and at the same time receive some kind of a guaranty or warranty of a return or “win” for each unit of chance purchased over a given time period. Such a guaranty, warranty, or guaranteed win is a primary object of this novel invention.

Heretofore, for example, in systems devised by Nilssen as disclosed in 1992 in U.S. Pat. No. 5,083,782, a central entity issues lottery tickets to various persons, in exchange for money in dollar denominations. A central entity cumulates the money thereby received and uses it for generating earnings, such as interest or dividends from investments. The holder of each lottery ticket is entitled only periodically to participate in lottery drawings by which a portion of the earnings for a preceeding period is paid to merely one or a few of the lottery ticket holders. As a result, each lottery ticket is in effect everlasting, participating in lottery drawings on a periodic basis, such as once each week, for an indefinitely long duration. Nilssen points out an example of this prior art system, namely, that at an earnings rate of 10% per annum and with a total of $10 billion having been accumulated in lottery receipts, the weekly earnings would be about $20 million, which, if disbursed over a period of 20 years or so, as is typically done by state lottery systems, could be touted as amounting to a $50 million lottery prize. However, this prior art system fails to provide the guarantee which is a central feature of the novel invention.

In an unrelated patent, Nilssen discloses an example of a method whereby a financial institution, such as a bank, issues numerous uniquely coded certificates to various individual entities in exchange for monetary value received. The holder of each certificate is entitled to receive a certain average rate of income from the monetary value represented by that certificate; which average rate of income would generally be proportional to prevailing interest rate as well as to the monetary value represented by the certificate. To avoid the relatively high transaction costs associated with periodic payments of a relatively modest income to the holder of each of numerous individual certificates, a statistical method is used. By way of this statistical method, a relatively few of the numerous uniquely coded certificates are randomly chosen at the end of each of a continuous sequence of time periods, and all the income attributable to all the issued certificates for the associated time period is then paid to the holders of the relatively few certificates chosen for that time period. Alternatively, the earnings resulting from the monetary values received are simply retained and added to the total fund of money underlying the certificates, thereby causing the monetary value of each certificate to grow over time. Thus, the total earnings attributable to a given certificate is continuously cumulated and added to the value represented by that certificate. In U.S. Pat. No. 4,997,188 Nilssen discloses another system for providing dividend paying traveler's checks.

A remotely related prior art lottery system was disclosed in U.S. Pat. No. 5,280,426 issued on Jan. 18, 1994 to Edmonds entitled, “Computerized Network for Subscribing/Purchasing Into Games of Chance”. The network disclosed is the basic system utilized in state sponsored lotteries whereby units of chance are sold by remote agents and teaches away from the novel invention exclaiming the system does not offer guarantees or intermediation between a subscriber/purchaser and an issuer or offeror and resolves only the problem of the inability of being able to be physically and personally present to subscribe or purchase into games of chances in multiple and/or distant states.

### SUMMARY

The novel system and method embodying the teachings of the present invention enables a new class of lottery game wherein each player is guaranteed a certain minimum win at least equal to amount wagered by combining features of an annuity and a tontine. The system requires that an investable portion of the amount wagered, preferably 50%, be set aside in a numbered account for a pre-specified time period, 20 years, for example. The system further requires that a wager portion or wager balance of the amount wagered is entered as a unit chance in a standard lottery with winners of the lottery presently selected from a predefined set according to the number of matching elements or numbers correctly selected by the player. A wager ticket is issued for each wager unit with a pre-assigned account number which is preferably re-used by the player for each subsequent wager. The investable portions and investment earning are cumulated to the account number. Each wager ticket is a bear bond.

The bond is collectable at the end of a specified period determined by a link to a previously issued account number of a certain determinable age. The system incorporates a method where tickets bearing different account numbers may be combined into a current or new account by presenting one or more tickets and paying a transaction fee, 25 cents for example, at a vendor terminal which scans the bar code or an equivalent for the account numbers of the tickets. Any ticket not redeemed has it value rolled over into a tontine fund for the remaining outstanding ticket and account holders.

### OBJECTS OF THE INVENTION

It is a main object of the present invention to provide immediate lottery type recreational play for a defined wager combined with a guaranteed return of a money sum after a period of time to each wager ticket holder by tracking the wager and ticket via an assigned account number which is transferable in the same manner as a bearer bond.

It is another object of the present invention to provide and integrate a modified tontine system where unclaimed ticket accounts for which the claim period has expired are rolled over into a fund for the benefit of the accounts of pre-existing ticket holders.

It is yet another object of the present invention to provide a lottery system with a built-in annuity with guaranteed value at least equal to 50% of the total of all wagers by a participant.

It is still another object of the present invention to provide a lottery system wherein lottery tickets are encouraged to be kept and retain a certain value in the same manner as bearer bonds.

It is an object of the invention to provide a step whereby the values represented by two or more tickets can be combined into a single numbered account for the benefit of the bearer of the surviving ticket account number or it progeny.

It is an object of the invention, that any ticket vendor is paid a transaction fee for combining account numbers.

It is further contemplated that the novel lottery, annuity, and tontine system imposes a transaction fee to encourage a single account number for each participant and provides a portion of the transaction fee to the lottery operator for maintenance expenses.

### BRIEF DESCRIPTION OF THE DRAWINGS

These and other features, aspects, and advantages of the present invention will become better understood with regard to the following description, appended claims, and accompanying drawings wherein:

FIG. 1 is a flow diagram of the essential steps of the novel dual lottery, gaming, annuity and modified tontine system for providing a guaranteed payoff to each player.

### DESCRIPTION OF THE PREFERRED EMBODIMENT

The present invention will be described hereinafter with reference to the accompanying drawings which illustrate a preferred embodiment of the invention.

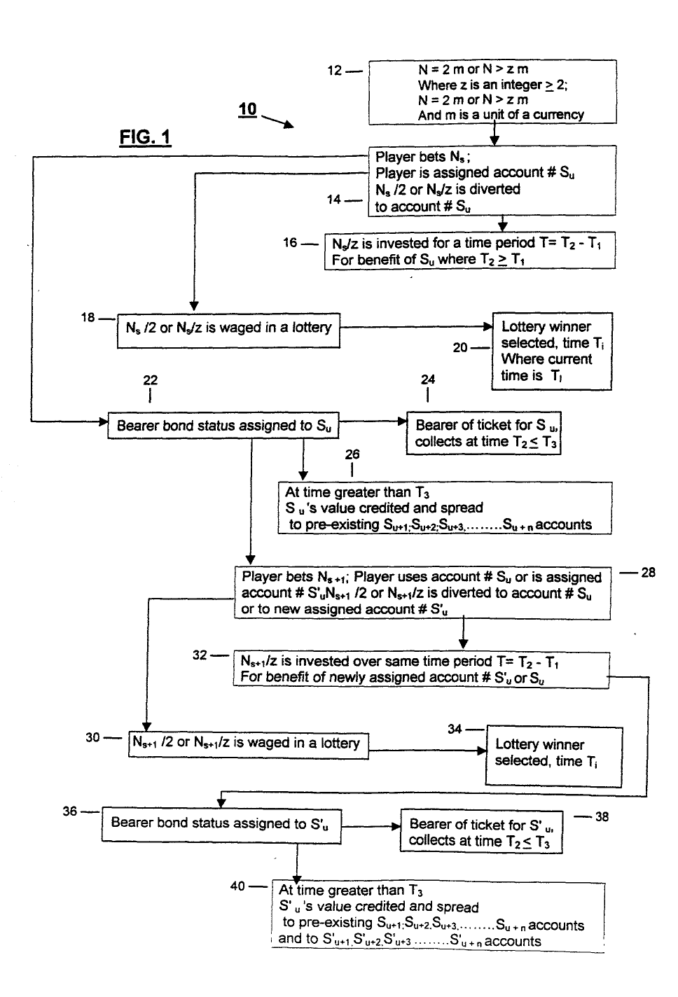

Shown in FIG. 1 is a flow diagram of the steps of dual annuity and lottery gaming system which guarantees a determinant and finite payoff to each participant or his or her heirs living at specified future time and date D for a percentage of wagers and investment earning thereon accumulated within a period in between a first time T₁ and a second time T₂. The finite payoff vests after the time T₂. The finite payoff must be claimed before a third time T₃. After the third time T₃, any unclaimed accounts are rolled into a fund and distributed to the remaining subsisting account holders. Wagers are preferably in denominations of at least double multiples of a specified currency, for example two dollars. Wagers are preferably divided into at least two equal parts or portions. One portion is a lottery portion and is used to fund a conventional lottery, for example the lottery as disclosed in U.S. Pat. No. 5,082,275 entitled “High-Return Lottery Process and System” issued to Nilssen on Jan. 21, 1992 and hereby incorporated herein by reference.

Another portion of the wager is the investment fund portion and is used to fund an annuity operated by an independent investment corporation created for such purpose by the entity operating the lottery. An account is created and managed; and combined when requested, for each lottery ticket purchased. The accounts are managed in a manner such as described in U.S. Pat. No. 5, 083,782, entitled “Financial Instruments and Systems” issued to Nilssen on Jan. 28, 1992 and hereby incorporated herein by reference.

In the novel lottery system, N=2 m or N>zm where z is an integer≧2. And, m is representative of a unit of a currency, for example dollars. A lottery player, bettor, bets an amount of currency Nₛ Each player is assigned account # S_{u.} An amount of money

Nₛ/2 or Nₛ/z is diverted to account # Sᵤ. The money sum Nₛ/z is invested for a time period

T=T₂−T₁ for benefit of Sᵤ where T₂≧T₁. At the same time the sum

Nₛ/2 or Nₛ/z is waged in a lottery. A usual and customary lottery winner selected during a time

T_{I} where current time is T_{I}.

Bearer bond status assigned and attributed to each account Sᵤ. Thus, the bearer of a ticket for Sᵤ, collects at the time T₂, where T₂≦T₃.

At a time greater than T₃, Sᵤ's value is credited and spread to pre-existing Sᵤ₊₁;Sᵤ₊₂, Sᵤ₊₃, . . . Sᵤ₊ₙ accounts.

Likewise, for subsequent wagers, N=2 m or N>zm where z is an integer≧2; and m is a unit of a currency. Thus, subsequently each same player retains or maintains an account number for the annuity and modified tontine benefit. This player bets and amount of currency equal to Nₛ₊₁. This player uses account # Sᵤ or is assigned account # S′ᵤ.

A new investment portion Nₛ₊₁/2 or Nₛ₊₁/z is diverted to account # Sᵤ or to new assigned account # S′ᵤ. Nₛ₊₁/z is invested over the same time period T=T₂−T_{1f} for the benefit of newly assigned account # S′ᵤ or Sᵤ.

Next a new lottery sum or wager portion Nₛ₊₁/2 or Nₛ₊₁/z is waged in a selected lottery with the purchase of additional lottery tickets. After, the next step is selecting a lottery winner.

This selection step occurs in present or instant time, i.e., time T₁. Similarly, the next step is assigning bearer bond status to the account and ticket bearing the account number S′ᵤ. Next, the bearer of the lottery ticket for S′ᵤ, collects the accrued annuity value at any time T₂≦T₃.

At any time greater than T₃S′ᵤ's value credited and spread to pre-existing Sᵤ₊₁;Sᵤ₊₂, Sᵤ₊₃, . . . Sᵤ₊ₙ accounts and to S′ᵤ₊₁, S′ᵤ₊₂, S′ᵤ₊₃, . . . S′ᵤ₊ₙ accounts. During the investment period T₂−T₁ the process and steps of splitting wagers into lottery portions and investment portions for each lottery ticket purchased under a specified account number is repeated again and again until a time T₃.

As this invention may be embodied in several forms and utilize each of many kinds of lottery such as those commonly known as Cash 5, Lotto, Power Ball, Pick 3, Pick 4, and scratch off tickets for prizes without departing from the spirit or essential characteristics thereof, the present embodiment is, therefore, illustrative and not restrictive, since the scope of the invention is defined by the appended claims rather than by the description preceding them, and all changes that fall within the metes and bounds of the claims or that form their functional as well as conjointly cooperative equivalent steps are, therefore, intended to be embraced by those claims.

What is claimed is:

1. An arrangement of a combination of a lottery and an annuity comprising:
first means operative to issue at least one lottery ticket bearing a unique account number to each of a plurality of individual entities; each individual entity paying a certain amount of money comprising at least two units of a currency for each such lottery ticket; each
individual entity becoming a holder of at least one lottery ticket; each
unique account number on each lottery ticket representing to its holder an undetermined dollar-equivalent annuity value after a future date certain;
second means functionally connected with the first means and operative to invest, via an investment entity, at least an investment unit of currency portion of the money received by the first means, the unique account number thereby to receive a flow of
financial earnings from each investment unit of currency portion attributed to said unique account number;
the investment unit of currency portion and the financial earnings therefrom vesting to the holder of the ticket bearing the unique account number after predetermined time period;
whereby the dollar-equivalent value of each of the amounts of fluids accredited to the holders of lottery tickets bearing unique account numbers is guaranteed payable to the bearer of each lottery ticket at a future date certain.

2. The arrangement of claim 1 wherein a lottery ticket has a guaranteed value equal to or greater than one half of the amount wagered by the holder under the preselected and specified account number over a pre-specified period of years.

3. A method for enabling the arrangement of claim 1 comprising the steps of:
(a) Issuing a lottery ticket for a pre-selected lottery game to a player for at least two units of a denomination of a currency;
(b) Assigning an account number to the lottery ticket;
(c) Depositing at least one unit of a denomination of the currency in an investment account;
(d) Associating the account number with the investment account;
(e) Issuing a subsequent lottery ticket for a pre-selected lottery game to said player for at least two units of a denomination of a currency;
(f) Assigning said account number to the subsequent lottery ticket;
(g) Depositing at least another unit of a denomination of the currency in the investment account;
(h) Specifying a first date after which any finds in the investment account will be actively invested;
(i) Specifying a second date after which activity attributed to the investment account ceases;
(j) Wagering at least one unit of a denomination of the currency in the pre-selected lottery game; and then,
(k) Selecting one or more winners of the pre-selected lottery game; and,
(l) Specifying a third date after which all sums in the investment account are payable to the bearer of the lottery ticket;
(m) Specifying a fourth date after which all sums in the investment account are paid into a tontine fund and the tontine fund is divided equally and vested amongst all pre-existing lottery ticket active account numbers;
(n) Periodically downloading the status of each account number to a computer server accessible via the internet
Whereby anyone using the account number as a user name and as a password accesses the account the account number represents and views the current value thereof.
